(19) United States
(12) Patent Application Publication
(10) Pub. No.: US 2026/0244926 A1
(43) Pub. Date: Aug. 20, 2026

(54) SYSTEMS AND METHODS FOR ENTROPY-BASED PRUNING OF NEURAL NETWORK MODELS

(71) Applicant: Salesforce, Inc., San Francisco, CA (US)

(72) Inventors: Yuhui Xu, San Francisco, CA (US); Juntao Tan, San Francisco, CA (US); Doyen Sahoo, Singapore (SG); Silvio Savarese, Palo Alto, CA (US); Caiming Xiong, Menlo Park, CA (US); Huan Wang, Palo Alto, CA (US); Shelby Heinecke, San Francisco, CA (US); Liangwei Yang, San Francisco, CA (US)

(21) Appl. No.: 19/204,982

(22) Filed: May 12, 2025

Related U.S. Application Data
(60) Provisional application No. 63/759,384, filed on Feb. 17, 2025.

(51) Int. Cl. G06N 3/082; G06T 1/20

(52) U.S. Cl. CPC G06N 3/082; G06T 1/20

(57) ABSTRACT

Embodiments described herein provide a method for hardware resource allocation during the operation of a generative neural network model. The method includes receiving a set of input data at a neural network-based model implemented on one or more hardware processors, where the model comprises a plurality of sequentially connected blocks. The method involves computing respective input and output intermediate values for at least one block during forward passes of the model, and calculating a change in entropy for each block based on the difference between entropy estimates for the input and output intermediate values. Blocks are pruned based on their respective changes in entropy, and hardware resources allocated to the pruned model are adjusted accordingly. The pruned neural network model is then operated using the adjusted hardware resources.

### CROSS REFERENCE(S)

The instant application is a nonprovisional of and claim priority under 35 U.S.C. 119 to U.S. provisional application No. 63/759,384, filed Feb. 17, 2025, which is hereby expressly incorporated by reference herein in its entirety.

### TECHNICAL FIELD

The embodiments relate generally to machine learning systems for Neural Network Models including AI agents, and more specifically to entropy-based pruning of neural network models.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

As the scale and complexity of neural network-based language models continue to increase, these models demand substantial computational and hardware resources, which can limit their practical deployment in real-world AI agent applications. Many large models contain significant redundancy within their internal computation blocks, resulting in inefficient use of resources and unnecessary latency.

### BRIEF DESCRIPTION OF THE DRAWINGS

FIG. 1 shows an example operation of an LLM based AI agent, according to embodiments of the present disclosure.

FIG. 2 illustrates a transformer framework according to some embodiments.

FIG. 3 illustrates an exemplary graph showing entropy levels associated with different blocks of a model, according to some embodiments.

FIG. 4 illustrates an entropy-based pruning framework, according to some embodiments.

FIG. 5A is a simplified diagram illustrating a computing device implementing the AI agent framework described in FIGS. 1-4, according to some embodiments.

FIG. 5B is a simplified diagram illustrating a neural network structure, according to some embodiments.

FIG. 6 is a simplified block diagram of a networked system suitable for implementing the AI agent framework described in FIGS. 1-5B and other embodiments described herein.

FIG. 7 is an example logic flow diagram illustrating a method of hardware resource allocation during a generative neural network model operation based on the framework shown in FIGS. 1-6, according to some embodiments.

FIGS. 8-14 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

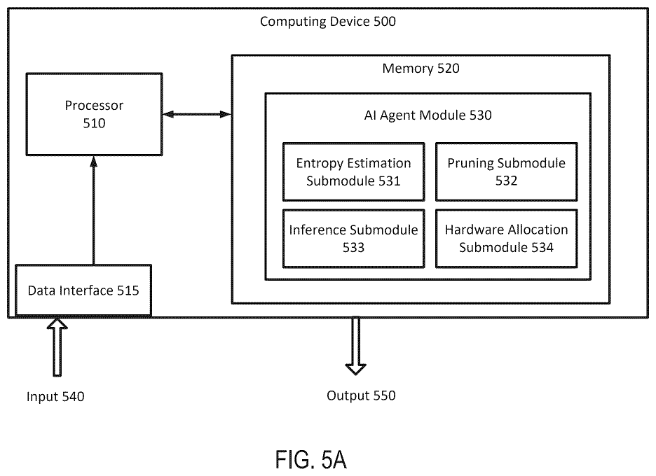

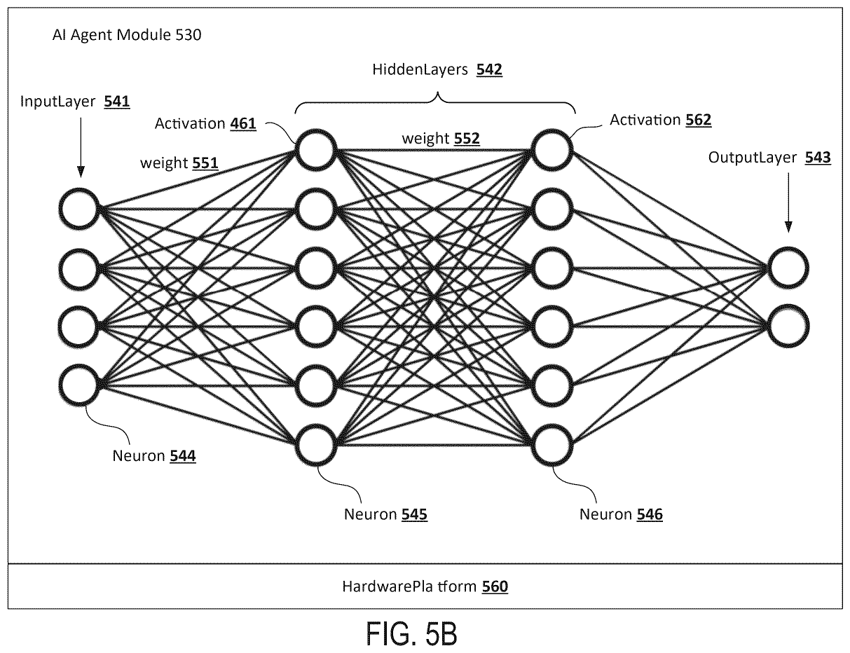

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

As the scale and complexity of neural network-based language models continue to increase, these models demand substantial computational and hardware resources, which can limit their practical deployment in real-world AI agent applications. Many large models contain significant redundancy within their internal computation blocks, resulting in inefficient use of resources and unnecessary latency. Existing approaches to model compression and acceleration often fail to effectively identify and remove these redundant components without degrading model performance.

Embodiments described herein provide a method and system for efficiently allocating hardware resources during the operation of generative neural network models, such as those used in large language models (LLMs) used in AI agents. These models are typically composed of a sequence of computation blocks, such as attention and feedforward (MLP) blocks in Transformer architectures that process input data through multiple layers to generate outputs. While these deep architectures enable impressive performance, they also introduce significant redundancy, with many blocks contributing little unique information to the final output. This redundancy leads to unnecessary computational overhead and increased hardware resource consumption, which can be a barrier to deploying such models in resource-constrained or real-time environments.

Embodiments herein introduce an entropy-based pruning strategy that dynamically identifies and removes redundant computation blocks from a neural network during operation. The method involves monitoring the flow of information through each block by computing the change in entropy of the intermediate values at the input and output of each block during one or more forward passes. By estimating the change in entropy for each block, the system can determine which blocks contribute the least to the model's information processing. Blocks with the lowest increase in entropy are considered less informative and are selected for pruning.

Once the less informative blocks are identified and pruned, the system reallocates hardware resources accordingly. This may include reducing the number of GPU threads or the amount of memory allocated to the now smaller, pruned model. The pruned model continues to operate, generating outputs based on the user's input but with improved efficiency and reduced computational demands. In some embodiments, a predetermined number of blocks are protected from pruning to preserve essential model functionality. The quantity of protected blocks can be determined automatically, for example, by identifying blocks with negative changes in entropy.

This entropy-based pruning framework is robust and generalizable, as it does not rely on the geometric similarity of hidden representations (as in traditional cosine similarity-based methods), but instead directly quantifies the information content and uncertainty at each stage of the model. As a result, the system can achieve substantial reductions in model size and inference time while maintaining high levels of accuracy and reliability. This enables more efficient deployment of AI agents and generative models in a wide range of practical applications, from customer service chatbots to real-time IT support, without sacrificing the quality of their responses.

Embodiments described herein provide a number of benefits. For example, by leveraging an entropy-based pruning strategy to identify and remove redundant computation blocks within large neural network models, computational efficiency is significantly improved, resulting in faster inference times and reduced hardware resource consumption. In another example, the use of entropy dynamics, rather than geometric similarity measures, enables more accurate identification of blocks that contribute little to the model's information processing, allowing for more aggressive pruning without sacrificing model accuracy. In another example, the ability to dynamically adjust hardware resources, such as reducing GPU threads or memory allocation after pruning, leads to more efficient utilization of computing infrastructure, which is particularly valuable for real-time or resource-constrained deployment scenarios. In another example, protecting critical early-stage blocks based on entropy trends ensures that essential information compression and model functionality are preserved, maintaining the reliability and robustness of the pruned model. In another example, the robustness of the entropy-based approach across different calibration datasets and entropy estimation methods demonstrates its generalizability and adaptability to a wide range of models and application domains. Therefore, with improved performance on efficient model deployment and inference, neural network technology in large language models and generative AI applications is improved.

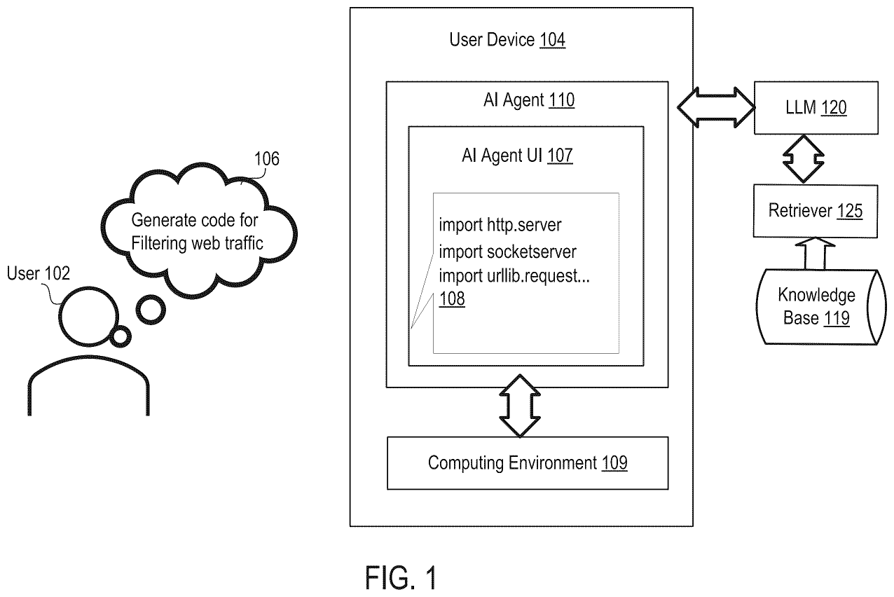

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “generate code for filtering web traffic” 106.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 5B.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to “generate code for filtering web traffic,” the LLM 120 may output a code script 108 to execute on the computing environment 109 (such as a web browser) on the user device 104 to filter web traffic, and/or interface with APIs of other applications to filter web traffic, and/or the like. In this way, the LLM-based AI agent may facilitate end-to-end workflow to automate the task request 106.

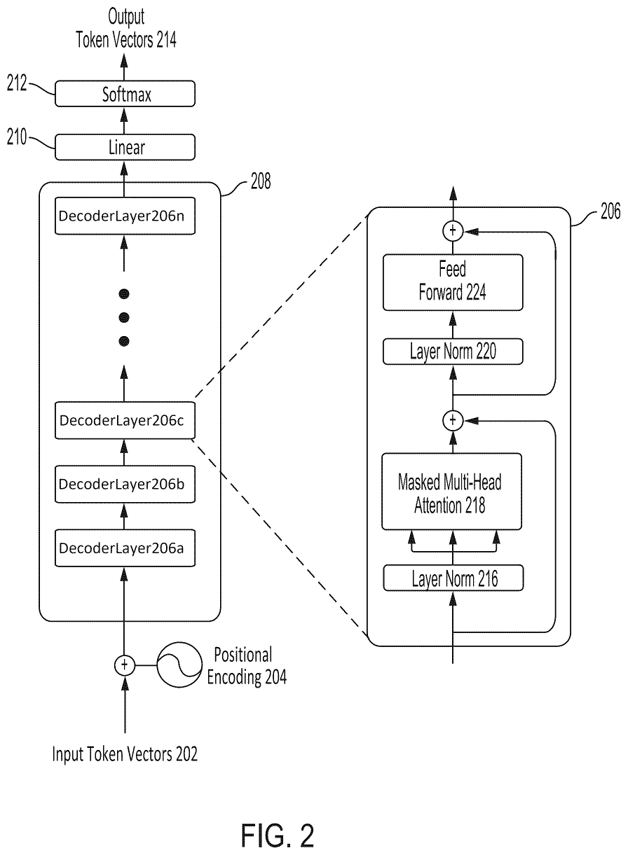

In some embodiments, AI agent 110 may generate outputs through the use of a multi-layer neural network model such as a transformer-based model. AI agent 110 may prune the model according to embodiments described herein. AI agent 110 may further reduce hardware allocation in response to the pruning as described herein, as further described in FIGS. 2-7 below.

FIG. 2 illustrates a transformer framework according to some embodiments. In some embodiments, AI agent 110 includes a LLM built at least in part including a transformer architecture as described in FIG. 2. For example, the Transformer architecture comprises multiple decoder layers 206, each consisting of self-attention 218 and feedforward 224 neural networks. The self-attention layer 218 transforms a set of input tokens (such as words) into different weights assigned to each token, capturing dependencies and relationships among tokens. The feedforward layers 224 then transform the input tokens, based on the attention weights, represents a high-dimensional embedding of the tokens, capturing various linguistic features and relationships among the tokens. The self-attention 218 and feed-forward 224 operations are iteratively performed through multiple layers 206 of self-attention and feedforward layers, thereby generating an output 214 based on the context of the input tokens 202 (which may be in the form of vectors, and as there are multiple vectors concatenated that may be considered a matrix). One forward pass for an input tokens 202 to be processed through the multiple layers 206 to generate an output in a Transformer architecture often entail hundreds of teraflops (trillions of floating-point operations) of computation.

For example, the Transformer-based architecture may process an input sequence of tokens 204 (e.g., letters, symbols, numbers, signs, words, etc.) using an encoder-decoder architecture (for tasks such as machine translation, etc.) or just the encoder (for classification tasks) or decoder (for generation-only tasks) as illustrated in the example of FIG. 2. First, the input sequence may be tokenized and converted into embeddings, which are dense numerical representations, e.g., vectors of values. Positional encodings 204 are added to these embeddings to provide information about the order of tokens.

In embodiments utilizing a transformer encoder, the transformer encoder may consist of multiple layers, each of which may processes the input using a multi-head self-attention mechanism to capture relationships between tokens and a feed-forward network to transform the information, resulting in encoded representations of the input sequence of tokens.

In a decoder-only architecture as illustrated, each decoder layer 206 may include a masked multi-head attention 218 and feed forward 224. In some embodiments, normalization layers 216 and 220 may be provided before each of the multi-head attention 218 and feed forward 224 respectively. Further, residual connections may be used around the norm 216 and multi-head attention 218 and/or around layer norm 220 and feed forward 224. By feeding previous outputs back into the input, the model may be used to auto-regressively determine the next token in a sequence. The Transformer decoder 208 may generate output tokens one by one, with each step using the previously generated tokens as part of the input and updated attention weights. The Transformer decoder 208 may include a linear layer 210 and softmax function 212 to predict probabilities for the next token in the sequence, selecting the most likely one to continue the output. This process repeats until a special end token is generated or a length limit is reached.

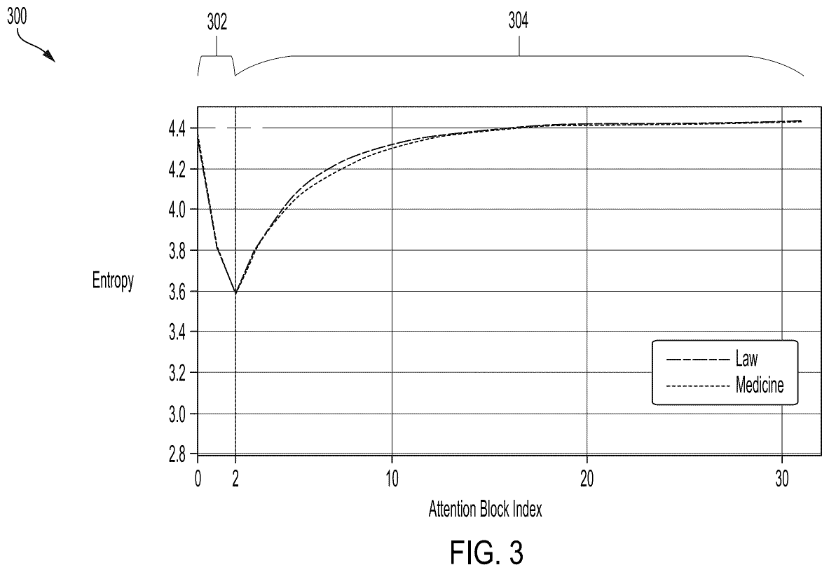

FIG. 3 illustrates an exemplary graph showing entropy levels associated with different blocks of a model, according to some embodiments. The x-axis is the attention block index for a transformer model, and the y-axis represents a measure of entropy of the input to the attention block at that index. The values represent the average entropy at each stage for two different datasets (law and medicine), each showing similar entropy levels, which shows that the entropy change in a model is not heavily dependent on the specific data. As shown, the transformer model generally has a first stage in which entropy is decreasing, followed by a second stage in which entropy is increasing and plateauing. In other words, in the early layers, entropy progressively decreases, suggesting that the model compresses information, filters redundant features, and forms compact representations. In the later stage, entropy gradually increases, indicating that the network enriches hidden state representations and expands contextual information.

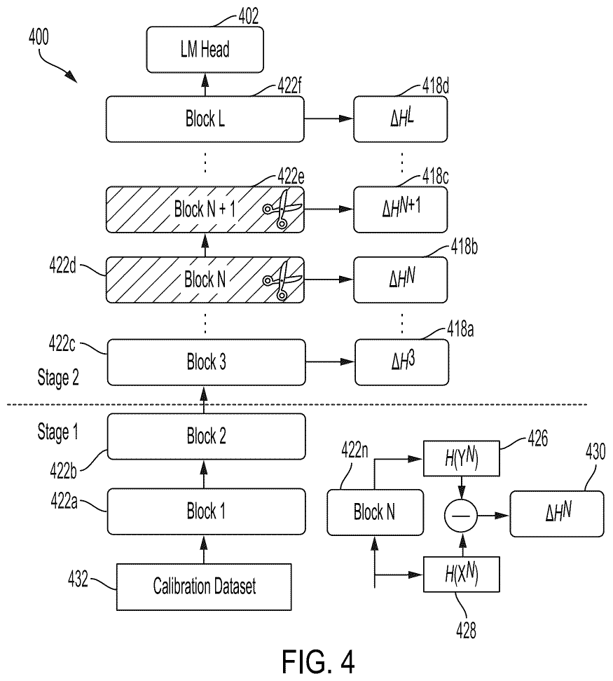

FIG. 4 illustrates an entropy-based pruning framework, according to some embodiments. Framework 400 encompasses a sequence of computation blocks 422, which may be implemented as transformer decoder layers, such as decoder layers 206 described in FIG. 2. In some embodiments, blocks 422 may be other neural-network based blocks such as self-attention layers, cross-attention layers, multi-layer perceptron (MLP) layers, transformer encoder blocks, latent-diffusion layer blocks, etc. These blocks 422 are connected in series, beginning with block 422a and continuing through subsequent blocks 422b, 422c, 422d, 422e, and 422f. Block 422n generically represents any block 422 in the sequence. The framework 400 is designed to optimize hardware resource allocation during the operation of a generative neural network model by identifying and removing redundant computation blocks based on entropy dynamics, as described herein.

The process begins with a calibration dataset 432, which is used to pass representative input data through the sequence of blocks 422. LM head 402 is used to process the final output for downstream tasks, but the focus of the pruning process is on the intermediate representations within the blocks 422. For each block, as represented in FIG. 4 by block 422n, the framework computes an entropy estimate 428 for the input to the block and an entropy estimate 426 for the output of the block. For example, the input and output may be one or more vectors. The change in entropy 430 for block 422n is then calculated as the difference between entropy estimate 426 (output) and entropy estimate 428 (input). This calculation is performed for each block in the sequence, resulting in a set of changes in entropy 418, including 418a, 418b, 418c, and 418d, where, for example, 418a corresponds to the change in entropy for block 422c, and subsequent indices correspond to later blocks. Changes in entropy may also be computed for blocks 422a and 422b not shown in FIG. 4.

In the illustrated example, blocks 422a and 422b (blocks 1 and 2) are designated as stage 1, where the entropy of the hidden representations decreases, indicating that these early blocks are compressing and structuring the input information. According to the empirical observations described in FIG. 3, these initial blocks are critical for information retention and may be protected from pruning. The remaining blocks, from 422c through 422f (blocks 3 through L), are in stage 2, where the entropy begins to increase across the sequence. This increase in entropy suggests that these later blocks are expanding and enriching the hidden state representations, and, as a result, may contain redundancy suitable for pruning.

In some embodiments, the first k layers are protected from pruning. The value k may be configured manually by a user, for example based on empirical testing. In some embodiments, the value k may be determined based on the change in entropy values determined with a calibration dataset. For example, k may be determined based on the number of first layers which decrease entropy. In some embodiments, later layers may decrease entropy by a small amount, but not be protected from pruning as they are not one of the first layers. The may be done by protecting all the layers that decrease entropy that come before the first layer in which entropy increases. In some embodiments, every layer that decreases entropy is protected from pruning. In some embodiments, layers which decrease entropy more than a threshold amount are protected from pruning. The threshold amount may be manually configured, or automatically determined based on a metric such as a desired accuracy.

In some embodiments, the number of blocks 422 which are pruned may be automatically determined. For example, the K unprotected blocks 422 with the lowest change in entropy may be pruned. In some embodiments, K may be a configurable value by a user. In some embodiments, K may be determined based on a desired accuracy level, with K iteratively selected using a calibration dataset in order to achieve the desired accuracy level according to some accuracy metric. For example, a batch of calibration data may be used as inputs to the model, with a certain K number of blocks pruned, and an accuracy metric determined on average across the input data in the batch. If the average accuracy in the batch is below a preconfigured threshold, then the value of K may be decreased and another batch of input data may be used. This process may repeat until the model reaches a sufficient accuracy level, at which point the value of K may be fixed. In some embodiments, a calibration process may be performed for each type of data input. For example, different domains of data may require greater or fewer pruned blocks.

The framework 400 leverages the computed changes in entropy 418 to identify which blocks in stage 2 contribute the least to the overall information flow. Specifically, blocks with the lowest changes in entropy are considered less informative and are selected for pruning. In some embodiments, pruning is performed based on the respective change in entropy for each block. Once the blocks to be pruned are identified, they are removed from the model, and the hardware resources allocated to the neural network are adjusted accordingly. This may include reducing the number of GPU threads or the amount of memory allocated.

In some embodiments, AI agent 110 utilizes a pre-trained Transformer model consisting of L computation blocks, each responsible for transforming hidden states as the input propagates through the network. Given a calibration dataset [symbol] , input samples may be passed through the model and hidden states collected at each block:

$${Z}^{l} = {f}_{l} ( {Z}^{l - 1} ) , l = 1 , 2 , … , L \qquad ( 4 )$$

where Z^{l} represents the hidden state at the 1-th block, and fₗ(●) denotes the computation block function (e.g., Attention, MLP). Once the hidden states at all blocks are obtained, the system estimates the entropy of each block and ranks them according to their entropy increase values. The lowest K blocks, which exhibit minimal entropy increase, are selected for pruning.

Embodiments herein may leverage a two-stage pruning strategy based on entropy observations. Stage 1 compresses the information, and no computation blocks are pruned in this stage. Stage 2 gradually increases the entropy, suggesting that these blocks perform similar hidden state enrichments. The transition point between the two stages, denoted as Sₛₜₐᵣₜ, may be determined using a calibration dataset. To effectively estimate the importance of computation blocks, entropy increase may be defined as:

$$Δ {H}^{l} = H ( {Z}^{l} ) - H ( {Z}^{l - 1} ) , \qquad ( 5 )$$

where H(●) represents the entropy estimation function. Blocks in Stage 2, indexed by Sₛₜₐᵣₜ≤l≤L, are ranked in ascending order based on their entropy increase:

$$Rank ( Δ {H}^{l} ) = argsort ( Δ {H}^{l} ) for l \geq {S}_{start} \qquad ( 6 )$$

Finally, the K blocks with the smallest entropy increase within Stage 2 are selected for pruning:

$${𝒮}_{prune} = \{ {f}_{i} \vert {f}_{i} ∈ {Rank ( Δ {H}^{l} )}_{Sstart}^{: L} [ : K ] \} , \qquad ( 7 )$$

where [symbol] ₚᵣᵤₙₑ denotes the set of pruned blocks and ΔH^{l} represents the entropy increase of l computation block. The bottom K ranked layers are pruned to optimize efficiency. Multiple different entropy estimation methods may be used, including bucket-based estimation, k-nearest neighbors (KNN) estimation, or Renyi entropy. Bucket-based estimation Discretizes activation values into bins and estimates entropy based on frequency distribution. K-Nearest Neighbors (KNN) computes entropy by estimating local density using KNN. Renyi Entropy is a generalization of Shannon entropy that provides a tunable parameter to control sensitivity to distribution variations.

Regardless of the estimation method used, entropy computation remains efficient, making entropy a practical metric for a pruning strategy. Experimental results demonstrate that bucket-based estimation and KNN-based estimation were found to be particularly effective in preserving model accuracy.

By applying this entropy-based pruning strategy, framework 400 enables the operation of a pruned neural network model on adjusted hardware resources, maintaining model performance while improving computational efficiency. When a block is pruned, the original input to that block becomes the input to the next un-pruned block in the sequence. The use of entropy estimates, as opposed to other measures such as geometric similarity measures, provides a more reliable criterion for identifying redundant computation blocks, ensuring that only those blocks with minimal contribution to information content are pruned.

### Computer and Network Environment

FIG. 5A is a simplified diagram illustrating a computing device implementing the AI agent framework described in FIGS. 1-4, according to one embodiment described herein. As shown in FIG. 5A, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In another embodiment, processor 510 may comprise multiple microprocessors and/or memory 520 may comprise multiple registers and/or other memory elements such that processor 510 and/or memory 520 may be arranged in the form of a hardware-based neural network, as further described in FIG. 5B.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for AI agent module 530 that may be used to implement and/or emulate the systems and models, and/or to implement any of the methods described further herein. AI agent module 530 may receive input 540 such as an input training data (e.g., prompts and responses) via the data interface 515 and generate an output 550 which may be a text response.

The data interface 515 may comprise a communication interface, a user interface (such as a voice input interface, a graphical user interface, and/or the like). For example, the computing device 500 may receive the input 540 (such as a training dataset) from a networked database via a communication interface. Or the computing device 500 may receive the input 540, such as a user prompt, from a user via the user interface.

In some embodiments, the AI agent module 530 is configured to perform AI agent operations using a neural network based model with entropy-based pruning. The AI agent module 530 may further include entropy estimation submodule 531, configured to estimate entropy as described in FIG. 4. The AI agent module 530 may further include pruning submodule 532, configured to prune blocks as described in FIG. 4. The AI agent module 530 may further include inference submodule 533, configured to perform inference using the model (the full model and/or pruned model) as described in FIG. 4. The AI agent module 530 may further include hardware allocation submodule 534, configured to adjust hardware allocations based on model pruning as described in FIG. 4.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5B is a simplified diagram illustrating the neural network structure implementing the AI agent module 530 described in FIG. 5A, according to some embodiments. In some embodiments, the AI agent module 530 and/or one or more of its submodules 531-534 may be implemented at least partially via an artificial neural network structure shown in FIG. 5B. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5A), such as a user prompt. The number of nodes (neurons) in the input layer 541 may be determined by the dimensionality of the input data (e.g., the length of a vector of the prompt). Each node in the input layer represents a feature or attribute of the input.

The hidden layers 542 are intermediate layers between the input and output layers of a neural network. It is noted that two hidden layers 542 are shown in FIG. 5B for illustrative purpose only, and any number of hidden layers may be utilized in a neural network structure. Hidden layers 542 may extract and transform the input data through a series of weighted computations and activation functions.

For example, as discussed in FIG. 5A, the AI agent module 530 receives an input 540 of a prompt and transforms the input into an output 550 of a response (e.g., text). To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 530 and/or one or more of its submodules 531-534 may comprise the transformative neural network structure of layers of neurons, and weights and activation functions describing the non-linear transformation at each neuron. Such a neural network structure is often implemented on one or more hardware processors 510, such as a graphics processing unit (GPU). An example neural network may be a transformer model, and/or the like.

In one embodiment, the AI agent module 530 and its submodules 531-534 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the AI agent module 530 and its submodules 531-534 may be implemented by hardware, software and/or a combination thereof. For example, the AI agent module 530 and its submodules 531-534 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the AI agent module 530 and its submodules 531-534 and/or any other neural network models onto hardware platform 560, the neural network based modules 530 and its submodules 531-534 may be optimized for deployment by converting it to a suitable format, such as ONNX or TensorRT, to improve performance and compatibility. Next, depending on the size and workload requirements for modules 530 and its submodules 531-534, hardware types may be chosen for deployment, e.g., processing capacity, GPU memory size, and/or the like. Frameworks and drivers for the chosen hardware 560 frameworks and drivers may thus be installed, such as PyTorch, TensorFlow, or CUDA, to support the hardware platform 560. Then, weights and parameters of the AI agent module 530 and its submodules 531-534 may be loaded to the hardware 560. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 530 and its submodules 531-534 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the AI agent module 530 and its submodules 531-534 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 530 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent module 530 and one or more of its submodules 531-534 may be trained by iteratively updating the underlying parameters (e.g., weights 551, 552, etc., bias parameters and/or coefficients in the activation functions 561, 562 associated with neurons) of the neural network based on a loss function. For example, during forward propagation, the training data such as prompts are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding known-good response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based AI agent module 530 and one or more of its submodules 531-534 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

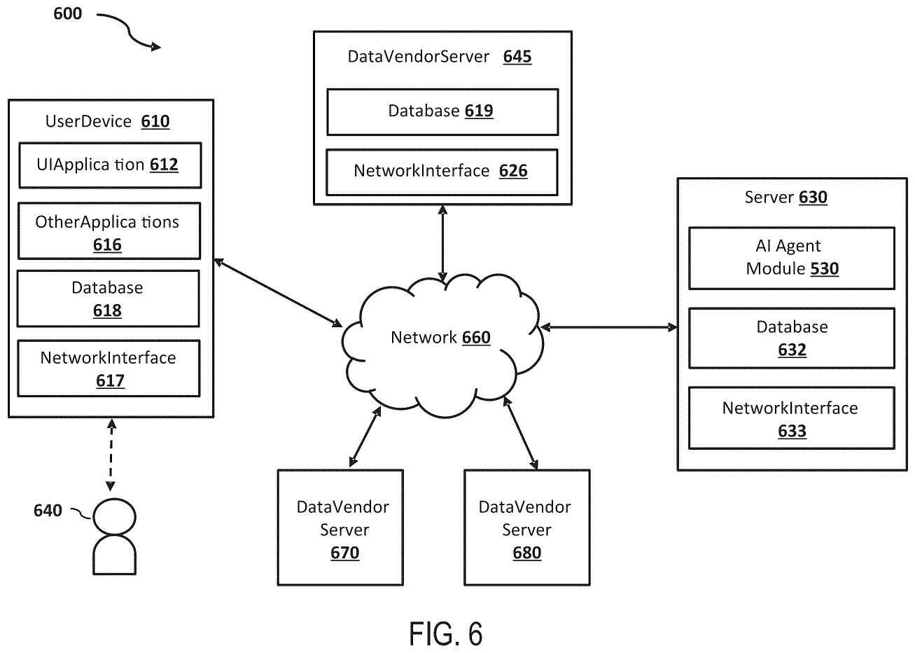

In some embodiments, AI agent module 530 and its submodules 531-534 may be housed at a centralized server (e.g., computing device 500) or one or more distributed servers. For example, one or more of AI agent module 530 and its submodules 531-534 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating responses to unseen user prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents.

FIG. 6 is a simplified block diagram of a networked system 600 suitable for implementing the AI agent framework described in FIGS. 1-5B and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a response from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 530 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 530 may generate a response via the process described in FIGS. 1-5B. The AI agent module 530 may thus cause a display of a response at UI application 612 and interactively update the display in real time with the user utterance. In some embodiments, the AI agent module 530 may generate code which is executed, and the results of that execution are displayed.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view responses.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including prompts to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 530 and its submodules described in FIG. 5A. In some implementations, AI agent module 530 may receive data from database 619 at the data vendor server 645 via the network 660 to generate responses. The generated responses may also be sent to the user device 610 for review by the user 640 via the network 660.

In one embodiment, an AI agent implementing the AI agent module 530 and its submodules described in FIG. 5A may be built based on an LLM as described in FIG. 5B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the AI agent module 530 and its submodules described in FIG. 5A may be implemented as a cloud-based AI agent which may be accessed by user device 610 via a chatbot application, a web application, customer support or SaaS applications. In another implementation, a client-side AI agent component may be delivered from the server 630 to user device 610 for local installation such that the client-side AI agent may be installed and runs directly on the user's device. Such local AI agent on the user device 610 may be available offline to adapt to privacy-sensitive applications. In another implementation, the AI agent implementing the AI agent module 530 and its submodules described in FIG. 5A may adopt a hybrid cloud and client-based structure to balance computing speed, cost and privacy. For example, a local AI agent may handle basic AI queries locally, but complex queries may be sent to server 630 to process.

The database 632 may be stored in a transitory and/or non-transitory memory of the server 630. In one implementation, the database 632 may store data obtained from the data vendor server 645. In one implementation, the database 632 may store parameters of the AI agent module 530. In one implementation, the database 632 may store previously generated responses, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

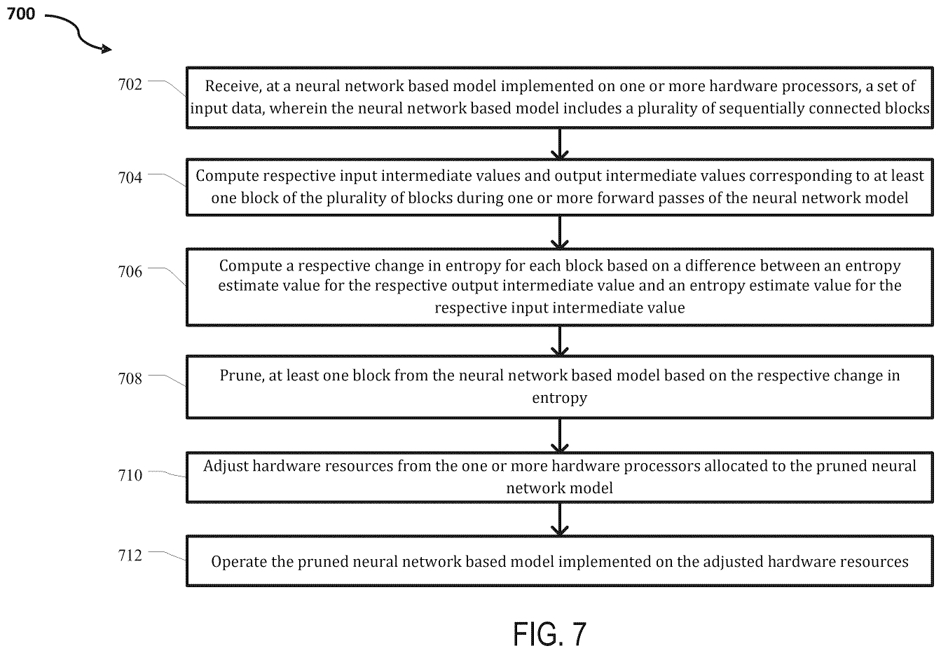

FIG. 7 is an example logic flow diagram illustrating a method of hardware resource allocation during a generative neural network model operation based on the framework shown in FIGS. 1-6, according to some embodiments. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 530 (e.g., FIGS. 5A and 6) that performs tasks as prompted by a user.

In some embodiments, method 700 is performed by a system such as computing device 500, user device 610, server 630, or another device or combination of devices. Inputs (e.g., user prompts) may be received via a data interface such as data interface 515, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

FIG. 7 is an example logic flow diagram illustrating a method of hardware resource allocation during a generative neural network model operation, according to some embodiments described herein.

At step 702, the system receives, at a neural network based model implemented on one or more hardware processors, a set of input data, wherein the neural network based model includes a plurality of sequentially connected blocks. In some embodiments, the system inputs a user prompt into the first block of the neural network based model and generates an output based on the user prompt, via a first subset of the plurality of blocks excluding pruned blocks of the plurality of blocks. This allows the model to process user input efficiently by leveraging only the necessary computation blocks.

At step 704, the system computes respective input intermediate values and output intermediate values corresponding to at least one block of the plurality of blocks during one or more forward passes of the neural network model.

At step 706, the system computes a respective change in entropy for each block based on a difference between an entropy estimate value for the respective output intermediate value and an entropy estimate value for the respective input intermediate value. In some embodiments, the entropy estimate values for the respective output intermediate value and the respective input intermediate value are computed based on at least one of: bucket-based estimation, k-nearest neighbors estimation, or Renyi entropy. This step quantifies the information contribution of each block, enabling the identification of blocks that are less informative or redundant.

At step 708, the system prunes at least one block from the neural network based model based on the respective change in entropy. In some embodiments, the pruning is performed based on pruned blocks having a lower respective change in entropy than other blocks of the plurality of blocks. In some embodiments, the system protects a predetermined quantity of blocks of the plurality of blocks from pruning. In some embodiments, the predetermined quantity is automatically determined based on a quantity of first blocks of the plurality of blocks having negative respective changes in entropy. This ensures that critical blocks, such as those responsible for initial information compression, are retained, while redundant blocks are removed to optimize efficiency.

At step 710, the system adjusts hardware resources from the one or more hardware processors allocated to the pruned neural network model. In some embodiments, adjusting hardware resources includes reducing at least one of: a number of GPU threads allocated to the pruned neural network model, or an amount of memory allocated to the pruned neural network model. For example, only model components and/or weights that remain after the pruning are loaded into and/or kept at the GPU memory. This dynamic adjustment of hardware resources allows for more efficient utilization of computational infrastructure, reducing operational costs and improving scalability.

At step 712, the system operates the pruned neural network based model implemented on the adjusted hardware resources. The pruned model continues to perform inference or generation tasks, now with reduced computational overhead and improved efficiency.

In some embodiments, method 700 is applicable in a variety of applications. For example, the task request received by a neural network model (e.g., AI agent 110) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may improve technology in the respective technical field in healthcare and diagnostics, education and personalized learning, software development and code assistance, content creation, autonomous system (such as autonomous driving, etc.), and/or the like.

In the domain of code generation and software development, embodiments described herein may be used to perform code generation more efficiently by removing blocks that contribute little to the information flow, as determined by entropy analysis. This results in faster response times and reduced memory usage, which is particularly valuable when integrating AI-powered code assistants into development environments or continuous integration pipelines.

Embodiments herein may be applied to IT diagnostics and control systems, where neural network models are used to monitor network traffic, detect anomalies, and automate responses to incidents. By pruning unnecessary computation blocks, the system can process large volumes of network data in real time with reduced latency and lower hardware requirements. This enables more efficient detection of network failures, unauthorized access attempts, or performance bottlenecks. The dynamic allocation of hardware resources ensures that IT monitoring systems remain cost-effective and scalable, even as network complexity grows.

Another application is in smart energy management systems, where neural networks may be used to forecast energy demand, optimize grid operations, and manage distributed energy resources. The claimed method allows these models to be deployed on local controllers or smart meters with limited hardware capabilities. By pruning redundant computation blocks and reallocating hardware resources, the system can deliver accurate predictions and control signals with minimal energy consumption. This not only improves the efficiency of energy distribution but also supports the integration of renewable energy sources and enhances the resilience of the power grid.

### Example Results

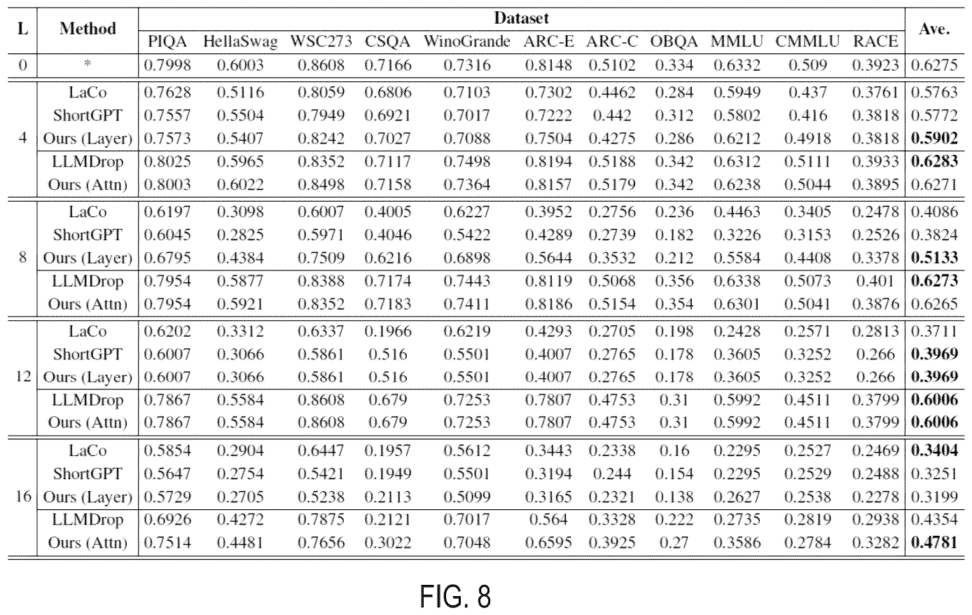

FIGS. 8-14 provide charts illustrating exemplary performance of embodiments described herein, with a comprehensive evaluation of the entropy-based block pruning method (labeled in experiments as EntroDrop) against several state-of-the-art baseline models and across a variety of metrics. The experiments were conducted on large language models, specifically Llama3.1-8B (Dubey et al., The llama 3 herd of models, arXiv:2407.21783, 2024) and Mistral-7B-v0.3 (Jiang et al., Mistral 7b, arXiv:2310.06825, 2023), with results shown for Llama3.1-8B unless otherwise specified. Baseline models used for comparison include LaCo (Yang et al., LaCo: Large language model pruning via layer collapse, Findings of the Association for Computational Linguistics: EMNLP 2024, 2024), ShortGPT (Men et al., ShortGPT: Layers in large language models are more redundant than you expect, arXiv:2403.03853, 2024), and LLMDrop (He et al., What matters in transformers? not all attention is needed, arXiv:2406.15786, 2024). The evaluation metrics span a diverse set of reasoning and comprehension benchmarks, including PIQA (Bisk et al., PIQA: Reasoning about physical commonsense in natural language, AAAI, 2020), HellaSwag (Zellers et al., Hellaswag: Can a machine really finish your sentence?, ACL, 2019), WSC273 (Sakaguchi et al., Winogrande: An adversarial winograd schema challenge at scale, Communications of the ACM, 2021), CSQA (Talmor et al., CommonsenseQA: A question answering challenge targeting commonsense knowledge, NAACL, 2019), WinoGrande (Sakaguchi et al., 2021), ARC-E and ARC-C(Clark et al., Think you have solved question answering? try arc, the ai2 reasoning challenge, arXiv:1803.05457, 2018), OBQA (Mihaylov et al., Can a suit of armor conduct electricity?A new dataset for open book question answering, EMNLP, 2018), MMLU (Hendrycks et al., Measuring massive multitask language understanding, ICLR, 2021), CMMLU (Li et al., CMMLU: measuring massive multitask language understanding in chinese, ACL, 2024), and RACE (Lai et al., RACE: Large-scale ReAding comprehension dataset from examinations, EMNLP, 2017). The main metrics reported are average accuracy across these benchmarks, with additional analysis on the impact of calibration datasets, entropy estimation methods, and inference speed.

FIG. 8 illustrates the overall performance of the entropy-based pruning method (EntroDrop) compared to baseline models on Llama3.1-8B. The results show that EntroDrop consistently achieves the best performance across both layer and attention pruning settings. Compared to LaCo and ShortGPT (layer pruning) and LLMDrop (attention pruning), EntroDrop achieves superior results, indicating that the entropy-based metric effectively identifies and prunes redundant computation blocks at different granularities. The experiments also demonstrate that pretrained Transformer models contain significant redundancy, especially in attention layers, with up to 12 layers (37.5% of total attention layers) removable while retaining over 95% of the model's original performance.

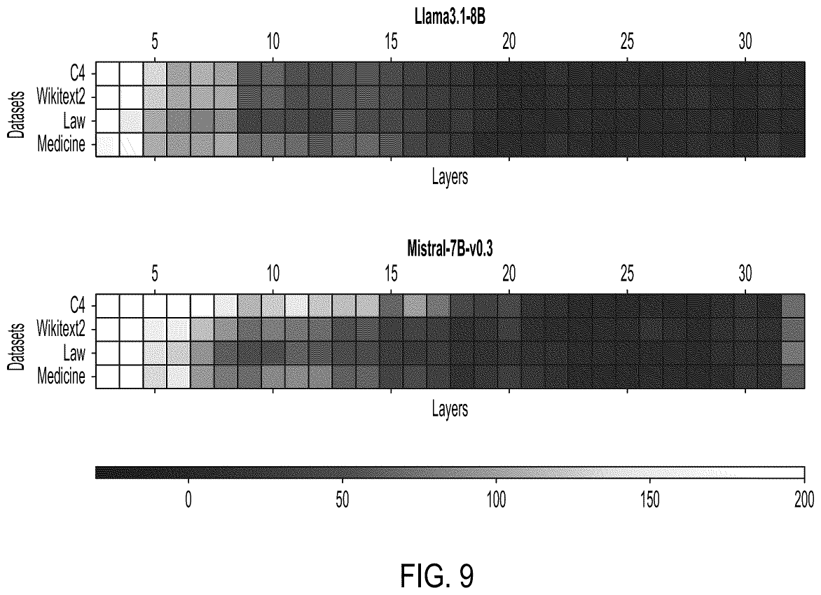

FIG. 9 illustrates the impact of different calibration datasets on the entropy increase heatmaps for Llama3.1-8B. The entropy increase is shown to be smaller in deeper layers, indicating that these layers contribute less to new information processing and are more redundant. This suggests that deeper layers are natural candidates for pruning. Despite differences in calibration datasets (C4, Wikitext2, Law, Medicine), the estimated entropy increase trends remain largely consistent, and the relative importance of layers is preserved across general and domain-specific datasets, suggesting that the entropy-based pruning approach is robust to calibration dataset variations.

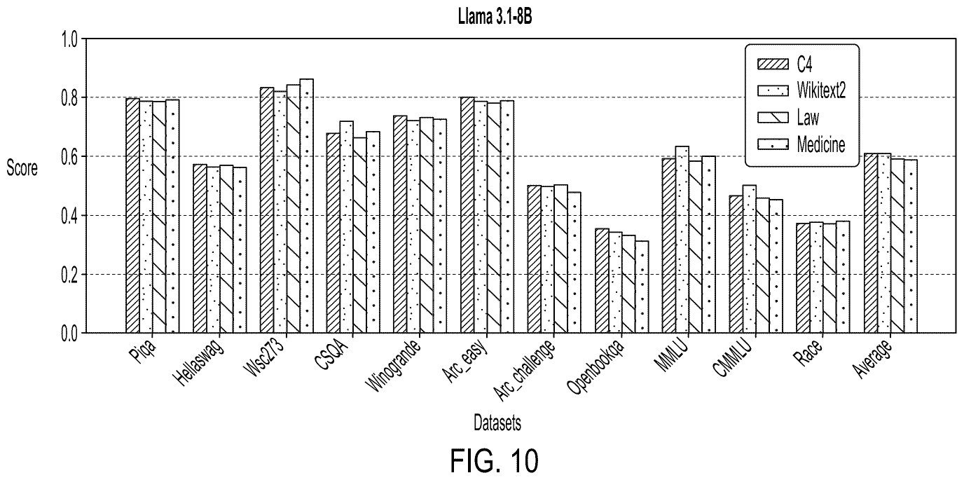

FIG. 10 illustrates the evaluation results of Llama3.1-8B after pruning 12 attention layers (37.5%) using different calibration datasets. The results show that different calibration datasets lead to minimal differences in performance across all benchmark datasets, reinforcing the robustness of the entropy-based pruning strategy. Even with domain-specific datasets (Medicine, Law), the average accuracy remains stable, indicating that the entropy estimation process generalizes well across different calibration datasets.

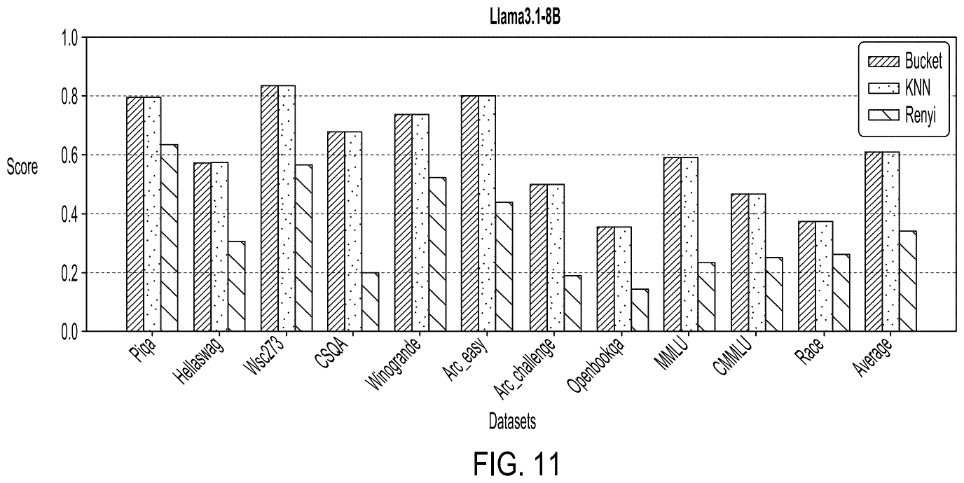

FIG. 11 illustrates the evaluation results of Llama3.1-8B after pruning 12 attention layers using different entropy estimation methods: Bucket-based, KNN-based, and Renyi entropy. The results indicate that the choice of entropy estimation method significantly affects performance. Both Bucket-based and KNN-based estimation methods yield stable and high accuracy across all datasets, demonstrating their effectiveness in preserving essential model capabilities after pruning. In contrast, Renyi entropy estimation consistently underperforms, leading to noticeable accuracy degradation.

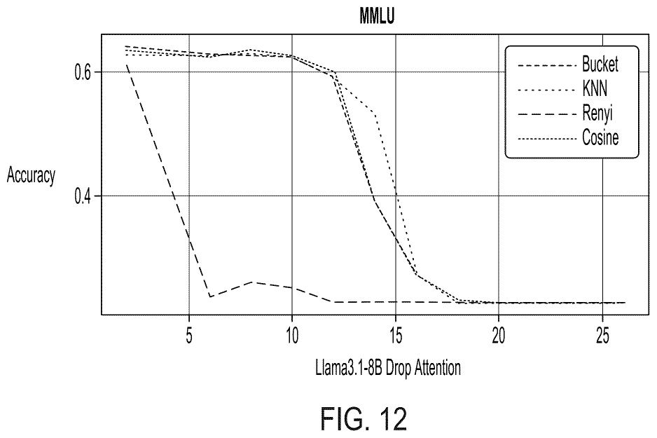

FIG. 12 illustrates the performance degradation trend on MMLU for Llama3.1-8B as attention layers are progressively removed. The results indicate that model performance remains stable until approximately 12 attention layers are removed, after which accuracy begins to degrade. This suggests that a significant portion of attention layers are redundant and can be pruned without substantial performance loss. Additionally, both Bucket-based and KNN-based entropy estimation methods consistently outperform Cosine Similarity, demonstrating their effectiveness in identifying unimportant attention layers, while Renyi entropy performs poorly from the beginning.

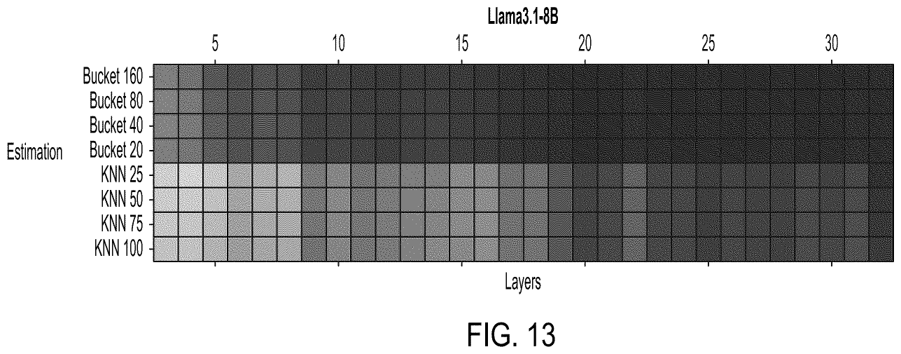

FIG. 13 illustrates the estimated entropy values across Transformer layers for Llama3.1-8B using different hyperparameter settings for Bucket-based and KNN-based entropy estimation methods. The results indicate that while different entropy estimation methods yield significantly different absolute entropy values, the relative importance ranking of layers remains largely unchanged within the same estimation method. This suggests that the choice of hyperparameter (e.g., number of bins for Bucket-based estimation, number of neighbors for KNN-based estimation) does not significantly impact the identification of redundant layers, highlighting the stability of entropy-based pruning.

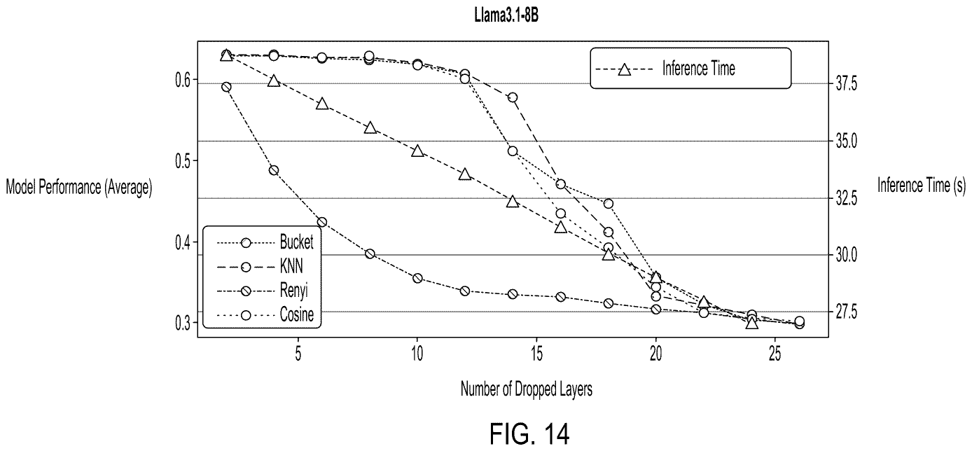

FIG. 14 illustrates the relationship between the number of dropped attention layers, model performance, and inference time for Llama3.1-8B. The results indicate that inference time decreases linearly as more attention layers are pruned. Notably, the first 12 layers provide the most significant speedup while maintaining model performance. Beyond this point, additional pruning begins to negatively impact accuracy. EntroDrop based on Bucket/KNN estimation outperforms the currently widely used cosine similarity. These results highlight that the method can achieve substantial computational savings while preserving accuracy, making it an effective strategy for accelerating large language models in real-world deployment scenarios.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of hardware resource allocation during a generative neural network model operation, the method comprising:
receiving, at a neural network based model implemented on one or more hardware processors, a set of input data, wherein the neural network based model includes a plurality of sequentially connected blocks;
computing respective input intermediate values and output intermediate values corresponding to at least one block of the plurality of blocks during one or more forward passes of the neural network model;
computing a respective change in entropy for each block based on a difference between an entropy estimate value for the respective output intermediate value and an entropy estimate value for the respective input intermediate value;
pruning, at least one block from the neural network based model based on the respective change in entropy;
adjusting hardware resources from the one or more hardware processors allocated to the pruned neural network model; and
operating the pruned neural network based model implemented on the adjusted hardware resources.

2. The method of claim 1, wherein the pruning is performed based on pruned blocks having a lower respective change in entropy than other blocks of the plurality of blocks.

3. The method of claim 2, further comprising:
protecting a predetermined quantity of blocks of the plurality of blocks from pruning.

4. The method of claim 3, wherein the predetermined quantity is automatically determined based on a quantity of first blocks of the plurality of blocks having negative respective changes in entropy.

5. The method of claim 1, wherein adjusting hardware resources includes reducing at least one of:
a number of GPU threads allocated to the pruned neural network model; or
an amount of memory allocated to the pruned neural network model.

6. The method of claim 1, further comprising:
inputting a user prompt into a first block of the neural network based model; and
generating an output based on the user prompt, via a first subset of the plurality of blocks excluding pruned blocks of the plurality of blocks.

7. The method of claim 1, wherein the entropy estimate values for the respective output intermediate value and the respective input intermediate value are computed based on at least one of:
bucket-based estimation;
k-nearest neighbors estimation; or
Renyi entropy.

8. A system for hardware resource allocation during a generative neural network model operation, the system comprising:
a memory that stores a neural network based model and a plurality of processor-executable instructions, wherein the neural network based model includes a plurality of sequentially connected blocks;
a communication interface that receives a set of input data; and
one or more hardware processors that read and execute the plurality of processor-executable instructions from the memory, wherein the plurality of processor-executable instructions are configurable to cause the system to perform operations comprising:
receiving, at the neural network based model implemented on one or more hardware processors, the set of input data;
computing respective input intermediate values and output intermediate values corresponding to at least one block of the plurality of blocks during one or more forward passes of the neural network model;
computing a respective change in entropy for each block based on a difference between an entropy estimate value for the respective output intermediate value and an entropy estimate value for the respective input intermediate value;
pruning, at least one block from the neural network based model based on the respective change in entropy;
adjusting hardware resources from the one or more hardware processors allocated to the pruned neural network model; and
operating the pruned neural network based model implemented on the adjusted hardware resources.

9. The system of claim 8, wherein the pruning is performed based on pruned blocks having a lower respective change in entropy than other blocks of the plurality of blocks.

10. The system of claim 9, wherein the plurality of processor-executable instructions are further configurable to cause the system to perform operations comprising:
protecting a predetermined quantity of blocks of the plurality of blocks from pruning.

11. The system of claim 10, wherein the predetermined quantity is automatically determined based on a quantity of first blocks of the plurality of blocks having negative respective changes in entropy.

12. The system of claim 8, wherein adjusting hardware resources includes reducing at least one of:
a number of GPU threads allocated to the pruned neural network model; or
an amount of memory allocated to the pruned neural network model.

13. The system of claim 8, wherein the plurality of processor-executable instructions are further configurable to cause the system to perform operations comprising:
inputting a user prompt into a first block of the neural network based model; and
generating an output based on the user prompt, via a first subset of the plurality of blocks excluding pruned blocks of the plurality of blocks.

14. The system of claim 8, wherein the entropy estimate values for the respective output intermediate value and the respective input intermediate value are computed based on at least one of:
bucket-based estimation;
k-nearest neighbors estimation; or
Renyi entropy.

15. A non-transitory machine-readable medium comprising a plurality of instructions, executable by one or more processors, wherein the plurality of instructions are configurable to cause the one or more processors to perform operations comprising:
receiving, at a neural network based model implemented on one or more hardware processors, a set of input data, wherein the neural network based model includes a plurality of sequentially connected blocks;
computing respective input intermediate values and output intermediate values corresponding to at least one block of the plurality of blocks during one or more forward passes of the neural network model;
computing a respective change in entropy for each block based on a difference between an entropy estimate value for the respective output intermediate value and an entropy estimate value for the respective input intermediate value;
pruning, at least one block from the neural network based model based on the respective change in entropy;
adjusting hardware resources from the one or more hardware processors allocated to the pruned neural network model; and
operating the pruned neural network based model implemented on the adjusted hardware resources.

16. The non-transitory machine-readable medium of claim 15, wherein the pruning is performed based on pruned blocks having a lower respective change in entropy than other blocks of the plurality of blocks.

17. The non-transitory machine-readable medium of claim 16, wherein the plurality of instructions are further configurable to cause the one or more processors to perform operations comprising:
protecting a predetermined quantity of blocks of the plurality of blocks from pruning.

18. The non-transitory machine-readable medium of claim 17, wherein the predetermined quantity is automatically determined based on a quantity of first blocks of the plurality of blocks having negative respective changes in entropy.

19. The non-transitory machine-readable medium of claim 15, wherein adjusting hardware resources includes reducing at least one of:
a number of GPU threads allocated to the pruned neural network model; or
an amount of memory allocated to the pruned neural network model.

20. The non-transitory machine-readable medium of claim 15, wherein the plurality of instructions are further configurable to cause the one or more processors to perform operations comprising:
inputting a user prompt into a first block of the neural network based model; and
generating an output based on the user prompt, via a first subset of the plurality of blocks excluding pruned blocks of the plurality of blocks.
